(19) United States
(12) Patent Application Publication
(10) Pub. No.: US 2026/0054213 A1
(43) Pub. Date: Feb. 26, 2026

(54) System, method, and device for the filtration, capture, and removal of particulates and other impurities from an atmosphere or gas stream

(71) Applicants: Daniel Deocampo, Avondale Estates, GA (US); Richard Jensen, Atlanta, GA (US)

(72) Inventors: Daniel Deocampo, Avondale Estates, GA (US); Richard Jensen, Atlanta, GA (US)

(73) Assignee: Nalari Scientific, LLC, Atlanta, GA (US)

(21) Appl. No.: 18/811,064

(22) Filed: Aug. 21, 2024

(51) Int. Cl. B01D 53/14; B01D 53/00; B01D 53/18

(52) U.S. Cl. CPC B01D 53/1493; B01D 53/007; B01D 53/18; B01D 2252/30

(57) ABSTRACT

The invention described herein is a system and method for the filtration and removal of non-gaseous impurities and other pollutants or unwanted materials from an environment or gas stream using ionic liquids. In this invention, the ionic liquid acts as a medium for the capture and removal of the targeted impurities to be filtered. Various embodiments of the invention employ different technologies, apparatuses, and mechanisms to bring the impurities to be captured into contact with the ionic liquid depending on the specific application and compounds or particles to be captured. This system, method, and device described herein may be implemented for terrestrial, microgravity, or aerospace applications. This invention also describes a method for using any liquid under centrifugal force to filter a gas stream under microgravity conditions.

### CROSS-REFERENCE TO RELATED APPLICATIONS

This application claims the benefit of priority to U.S. Provisional Application No. 63/533,890 filed Aug. 21, 2023, which is incorporated herein by reference.

### FIELD

The invention pertains to the removal of impurities and particles from a gas stream or environment, both for terrestrial and non-terrestrial applications.

### BACKGROUND

Separation of particulates from a volume of gas is required for many processes in industrial, aerospace, residential, medical, environmental, and other systems, as particulates may have deleterious effects on such systems. For example, human exposure to fine particulate matter (e.g. PM2.5) is strongly associated with symptoms of respiratory disease and biomarkers of inflammation (Van Tran et al., 2020). Particulate emissions into the environment from many applications, such as power plants and smelters, are therefore closely regulated worldwide to protect human health and the environment. Many types of specialized chemical processes also require removal of particulates. For example, efforts by NASA and others to recycle oxygen from carbon dioxide respired by crew members requires removing solid phase carbon particulates from Sabatier and pyrolysis effluent gas streams (Berger et al., 2017). The operational and efficiency requirements for particulate removal technologies are highly varied, depending on the particular needs of each application. These requirements, then determine which methods of particulate removal are applicable, subject to system constraints and costs.

Numerous existing technologies are used for the separation of particulates from a volume of gas. Conventional filtration traps particulates on a substrate either due to blockage based on particle size, or electrostatic and Van der Waals attractions following contact with the substrate (Perry et al., 2016). Substrates may be composed of a wide variety of materials, including woven or stacked fibers and polymers, as well as porous materials such as glass, ceramic, packed granular beds, or sintered metals. Although it is a mature technology, filtration suffers from several drawbacks that make it unsuitable for many applications, including filter clogging, limits on feasible flow rates, excessive pressure drop, need for maintenance and consumables, operating temperature limits, filter efficiency, and others.

A second category of methods for separation of particulates from a gas is based on contacting the particulates with a liquid, typically water, and then collecting it gravitationally or by other means. This includes numerous types of both sparging (ie bubbling the particulate-bearing gas through a column of liquid) and scrubbing (ie spraying the liquid through a gas stream). These approaches are widely used in industry, but they also suffer from drawbacks that make them expensive or unsuitable for many applications, including creation of a liquid waste stream, operating temperature constraints, gas-liquid contact time constraints, efficiency, volatilization of the liquid, and others.

A third category of methods for separation of particulates is electrostatic precipitation (ESP), in which particulates are charged, either actively or by tribocharging (frictional charging), and then impacted onto an oppositely-charged or grounded electrode by Coulombic forces in an applied electric field (EPA, 20). Particulates accumulated on the electrode are typically then collected gravitationally by either rapping (vibrating) the electrode, or by water washing either cyclically or continually. In addition to the challenges faced by other methods, ESP methods also face the challenges of high energy requirements and inefficiencies from electrode coverage by dust or water. Similarly, magnetic fields may be used to redirect the momentum vector of charged particles, although most true magnetic separation methods target permanently magnetic, paramagnetic, or diamagnetic particles, rather than electrostatically charged particles.

Another category of separation technology uses gas flow in a cyclonic vortex to drive particles to the circumference of the vortex, where they are collected, typically gravitationally. This approach is generally only suitable for large particulate grain sizes.

Many applications employ more than one of the above methods, for example placed in series, with the coarsest capture upstream designed as pre-filters for higher-efficiency finer-grained capture downstream. Despite the availability of many technologies for particulate separation, a need for innovation continues because the existing technologies, in many cases, have unacceptably high costs, low efficacy, or incompatibility with system requirements.

Removal of particulates from a gas stream is particularly relevant to air quality in residential, commercial, and workplace settings, as they represent potentially severe threats to human health (Van Tran et al., 2020). Hazardous airborne materials include, but are not limited to, PM10 and PM2.5, smoke, pathogens (ie viruses and bacteria), airborne organisms, other biological material (e.g. dander, pollen), organic compounds, inorganic compounds, and radioactive materials. Although ventilation and discharge of such contaminants to an external environment may be preferred, this option is often not available because it would cause the loss of heated or cooled interior air, thus increasing heating or cooling costs. Worldwide efforts to increase energy efficiency have also dramatically increased the insulation and sealing: of houses and other spaces, thereby increasing the concentration of indoor air pollutants and leading to greater human health impacts. Tightly-sealed homes and other spaces must therefore have some system of remediation to clean the air of hazardous impurities to protect human health. As discussed by Mata et al. (2022), numerous options are currently available for removing air pollutants, including filtration, adsorption, oxidation, and ionization. All of these have challenges of cost of materials, cost of operation, efficacy, throughput potential, and pollutant applicability and selectivity. Some air purification methods even create their own associated hazards, such as ozone and formaldehyde release associated with ionization (EPA, 2023). The present innovation is an advance over existing air purification technologies by addressing many of these challenges, as described in some respects herein.

Some of the particulate separation methods that achieve the highest efficiencies at the lowest energy costs are those, including some mentioned above, involving working liquids as a medium to capture particulates. These are particularly effective because once particulates are fully wetted or submerged, they are more difficult or even nearly impossible to entrain back into a gas stream, depending on gas velocity. Conventional methods use water, which presents its own challenges, such as electrical resistivity, corrosion of machine components, evaporation and potential contamination of the gas stream, treatment and disposal needs, and other issues. Other liquids such as organic solvents or hydrocarbons have similar or even greater problems that limit their suitability as a working liquid.

The development in recent years of ionic liquids (also known as “liquid ionic compounds”, “liquid salts”, or “molten salts”) has opened new frontiers in innovation due to the novel and unexpected behaviors of these fluids. The unique properties of ionic liquids make them promising potential working fluids for particulate capture applications in many settings, even though they have not been

The term “ionic liquid” here refers to one or more liquids, singularly or as a mixture, composed of ionic salts that are liquid at room temperature, also known as “liquid ionic compounds”, “molten salts”, or “liquid salts”. Some embodiments of the invention use a pure single ionic liquid, whereas other embodiments use a mixture of two or more ionic liquids. Mixtures of ionic liquids in some embodiments possess the individual properties of the constituent pure components, and in some embodiments mixtures of ionic liquids possess emergent properties only found in the mixtures and not found in the pure components.

Each ionic liquid molecule is composed of one cation, ionically bonded to an anion. Ionic liquid cations are composed of a core unit with one or more groups or chains of groups attached to it, with variable positions of attachment on the core unit. Possible cation core units include, but are not limited to, pyrrolidinium, pyridinium, pyridazium, piperidinium, imidazolium, ammonium, guanidinium, morpholinium, phosphonium, sulfonium, and others. Groups or chains of groups attached to the core units may include, but are not limited to, methyl, ethyl, propyl, butyl, pentyl, hexyl, heptyl, octyl, nonyl, decyl, dodecyl, or other groups or chains of groups, comprising, possibly by not exclusively, homogeneous hydrocarbon groups or chains of groups, or heterogeneous hydrocarbon groups or chains of groups containing, singly or multiply, fluorine, nitrogen, sulfur, phosphorous, or other heterogeneous component. Possible ionic liquid anions include but are not limited to, chloride, bromide, iodide, acetate, thiocyanate, hexafluorophosphate tetrafluoroborate, ethyl sulfate, methyl sulfate, trifluoroacetate, trifluorophosphate, trifluoromethylsulfonate, bis(trifluoromethylsulfonyl)imide, alkyl sulfate, triflate, dcyanimide, bis(pentafluoroethylsulfonyl)imide, diethyl phosphate, tris (pentafluoro-ethyl)trifluorophosphate, fluorinated sulfonates, trifluoromethanesulfate, pentanoate, propionate, perfluorobutanesulfonate, perfluoropentanoate, or other anion.

In all of the embodiments of this invention, the ionic liquids may be mixed with a variety of other possible compounds, chemicals, elements, or materials intended to enhance or induce certain effects or properties, or create new effects or properties that may be desired depending on the intended application. Some exemplary compounds, chemicals, materials, and substances along with the intended effects or uses are: scents or oils for air freshening and odor control; anti-microbial elements or compounds for health protection; minerals or engineered nanomaterials for sorptive or electromagnetic behavior; amino acids or proteins for biochemical reactivity; acid-base or oxidation-reduction reactants or reagents for buffering capacity or reactivity; other ions for ion exchange. This list is purely exemplary and is not limiting in any way. Some of these additions may be made prior to operation, and some may occur during or incidental to operation.

Following is a description of some physico-chemical processes relevant to the capture of solid particulates from a gas stream by a liquid that may be employed by some embodiments of the invention. This should not be construed as a description of any particular system or environment, nor should it be construed to limit the invention in any way.

Capture of a solid particulate by a discrete volume of liquid is defined as sufficient wetting of the surface of the particle such that the net of Van der Waals forces between the liquid and the solid, other components of liquid surface tension and viscosity due to irregular shape, and any momentum and acceleration differences between the liquid and the solid, are greater than those forces acting to entrain the particle in the gas stream, as shown in FIG. 1. Once sufficiently wetted by the capturing liquid, the captured particle will become submerged if the net of forces (e.g. gravitational or centrifugal) directed toward the liquid remain greater than the entrainment forces. Under microgravity, this will not be the case, and in fact droplets of the liquid itself may easily be entrained into the gas themselves. Once impacted on the surface of a coherent volume of liquid, the Van der Waals forces of interaction between the solid and liquid are generally much greater than the lifting forces of entrainment, even under high turbulence. Once submerged, the particles are fully isolated from the gas stream and unable to be entrained.

In order for a particle to contact the surface of the liquid, it must first travel a trajectory that penetrates the overlying boundary layer of gas, which may have variable velocities, high turbulence, and localized eddy currents that promote entrainment and inhibit contact. Capture of particulates by the liquid, therefore, is favored by conditions that multiply the particle vectors toward the surface of the liquid.

Gas-liquid contact may also be enhanced by sparging or scrubbing methods that also result in greater occurrence of particulate impacts with the liquid.

In addition to centrifugal, gravitational, advective, or diffusive forces, electromagnetic forces can affect the trajectory of particulates in a gas stream, and therefore contact with a liquid surface. Several means may be employed in order to electrically charge the particles, including the application of an electric field, (frictional) tribocharging, photoionization, application of electromagnetic radiation, bombardment with ionizing high energy particles, and extreme temperature (e.g. plasma generation). Depending on the electrical structure of the particles and the method of charging, particulates may acquire positive or negative charges of variable strength. Once charged, particulates are subject to electromotive forces, and hence may be moved or diverted, or separated from other particles of different charge. This is the basis for ESP technologies as discussed above.

One of the unique properties of ionic liquids is their relatively high electrical conductivity, similar to solid-state semi-conductors such as silicon. When doped with nanoparticle metallic conductors, electrical conductivity can be raised significantly higher as well. Whether actively charged as an ESP electrode (even at low voltage), or as a passive or grounded surface, ionic liquids therefore have enhanced electrostatic behaviors that can aid in particulate capture.

Electrostatic attraction or repulsion may either deflect the trajectory of moving particles in a gas stream, or aid in the final penetration of the boundary layer of gas at the liquid surface. The controlling factors are well known as they are the basis for ESP technologies, including the strength of the electric field, the charge, mass, and velocity of the particle, and the permittivity of the gaseous medium. (Jackson, 1999).

Similarly, magnetic fields may also deflect charged particulates moving in a gas stream. Such fields are commonly used for separation or sorting of paramagnetic or ferromagnetic materials (e.g. Fe203), but they may also alter the momentum vector of charged particles. The effect of a magnetic field on a charged particle is controlled by the strength and orientation of the magnetic field, the charge, mass, and velocity of the particle, (Griffiths, 2021). For example, a 100 nm diameter particle of graphene charged at −0.01 μC, travelling on a laminar flow trajectory of 1 m/s at the margin of a 2 cm diameter pipe, subject to a 1 T magnetic field with field lines oriented normal to flow would impact the opposite side of the pipe after about 10 s. A magnet capable of achieving such particle deflection could either be a permanent magnet, or a powered electromagnet.

Polarities of any electrical or magnetic deflection system would need to be appropriate to achieve particle deflection in the desired direction, while also accounting for the electromagnetic status an ionic liquid impact target. In addition, electromagnetic techniques such as those above can be applied so as to divert particulates that fail to impact the liquid away from the outlet of the capture device, thus increasing the residence time of particulates in the device and increasing capture efficiency.

As particles are captured at the surface of the liquid, depending on the resulting particle density on the surface of the liquid, some portion of the liquid surface becomes unavailable for further capture until the particles present become fully submerged. The time required for fully submerging a particle to a depth sufficient to allow penetration of another particle is based on the settling velocity of the particle, assuming an acceleration force is acting on the particle to further submerge it. The rate of settling is governed by the force acting on the particle (1.e. gravitational or centrifugal), the viscosity of the liquid, and the particle size, as described by Stokes' Law:

$${F}_{r} = 6 π {⌈}_{p} {v}_{p} μ \qquad Equation 1$$

where Fᵣ is the resistive force acting on the surface of the particle, rₚ is the particle's radius, vₚ is the particle's velocity relative to the fluid, and μ is the fluid viscosity, assuming a spherical particle and laminar flow. In a centrifuge, the effective gravitational force generated by centrifugal motion is described by

$${F}_{c} = m {ω}^{2} {r}_{c} \qquad Equation 2$$

where Fc is the centrifugal force, m is the mass of the centrifuged particle, w is the angular velocity of the centrifuge in revolutions per unit time, and r_{c} is the centrifugal radius. At terminal velocity, Equations 1 and 2 are equal, as acceleration is offset by viscous resistance (Bohren and Albrecht, 1997). Solving for the particle velocity, then,

$${v}_{p} = ( m {ω}^{2} {r}_{c} ) / 6 π {r}_{p} {v}_{p} μ \qquad Equation 3$$

Where m=(4/3) π r³ₚρ, and ρ is the particle density. Because the force under consideration (ie. centrifugal or gravity) is applied to both the liquid and the particle, the differential density between the solid and liquid should be used to determine the resulting velocity (Jackson, 1985); so

$${v}_{p} = ( 2 {r}_{p}^{2} {ω}^{2} {r}_{c} Δ ρ ) / 9 μ . \qquad Equation 4$$

This allows for an estimation of acceleration and settling times for particulates captured in a liquid while under centrifugation. For example, a 1 μm diameter carbon particle of ρ=2 gcm⁻³ in a centrifuge containing an ionic liquid of viscosity 0.092 Pa-s and 1.1 gcm⁻³, with the liquid surface 10 cm from the rotational axis spinning at 200 revolutions per minute, would settle at a terminal velocity of over 1 mm/s. Even at considerably finer grain sizes, the surface of the liquid rapidly clears for further accumulation of new particles, as captured ones accumulate below the liquid surface. Depending on particle composition, these accumulating particles may even alter the behavior of the liquid-particle mixture, for example contributing or altering electromagnetic or chemical properties.

Any device for the capture of particulates from a gas stream by ionic liquids would need to be able to accommodate the volume of captured particles while allowing for the continued capture of new particles. For some applications, this required volume accommodation is not very large—for example, the carbon particulate discharge of NASA's Plasma Pyrolysis Assembly operating at a rate to process CO2 generated by a crew of 4, generates about 1 g of carbon particulate per day in a H2 gas stream (Berger et al., 2017). With a density of about 2 gcm⁻³ this amounts to about 0.6 ml/day, or 200 ml/year. On the other hand, removing and capturing a dust coating 100 μm thick composed of lunar regolith covering about 1.7 m of an EVA space suit surface area would need at least 17 ml of accommodation for each single cleaning event. When low rates of capture are needed, it may not be necessary to remove the particulates from the ionic liquid for the projected life of the device component. When particulate volume capture rates are higher, though, it may be necessary to separate the particulates from the liquid to refresh the liquid and enable continued operation. Such separation could be achieved by a number of possible approaches, including centrifugation, filtration, or other technique.

### SUMMARY

The invention described herein is for a system and method that is for the removal of non-gaseous impurities from a gas stream. The invention uses a capture chamber containing an ionic liquid, with the capture chamber having inlet and outlet ports for gas movement through the chamber. The gas stream is contacted with the ionic liquid to capture non-gaseous impurities from the gas stream. Various means may also be employed for enhancing the capture of these non-gaseous impurities. These means include passive and active methods of alternating the gas stream dynamics, implementing electromagnetic separation technologies, such as magnetic separators or electrostatic precipitators, scrubbing technologies, bubble column and sparging technologies, and annular centrifugation. Another embodiment of this invention uses one or more surfaces or membranes for the ionic liquid to rest upon or flow upon and then places those membranes in the flow path of the gas stream in such a way as to create small spaces for the gas stream to flow between the surfaces, guaranteeing impaction of the non-gaseous impurities, while expanding the overall cross-sectional area of the flow path to limit any pressure drop. Finally, the present invention also includes the use of centrifugal force to create a stable liquid volume for use in filtering a gas stream in microgravity environments.

### DESCRIPTION OF THE DRAWINGS

FIG. 1. Diagrammatic representation of the capture system, showing source of environmental or process gas stream 1; incoming gas stream treatment such as pre-filtering, ionization, or other 5; capture chamber 10; means of separation of captured particles 15; liquid mist eliminator 70; and gas outlet or return to external environment or process 25.

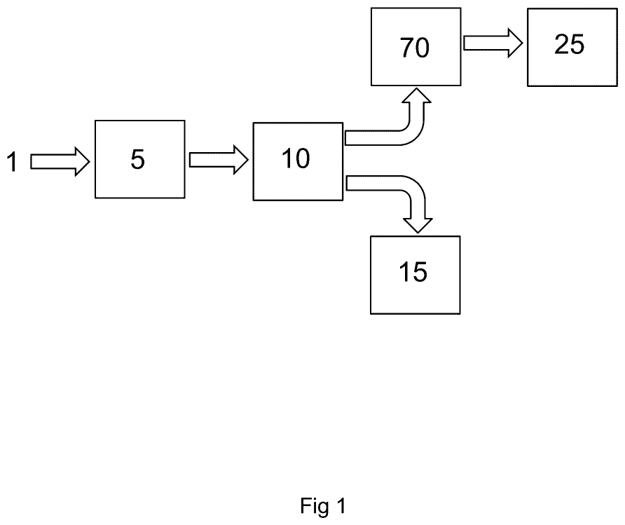

FIG. 2. A schematic representation of an example of a possible embodiment of the capture system. A residential air purification system, in-line or parallel, in an HVAC system, with a pretreatment device such as an ionizer, tribocharger, or similar 5; directional jets 30 to facilitate impaction and wetting of particles; turbulance inducing baffles 35 that are rotated in the ionic liquid 40 by a motor 45; a circulation and filtering device for the ionic liquid 50; means for electromagnetic separation of non-gaseous impurities 55; a mist eliminator 70 and a gas outlet 25.

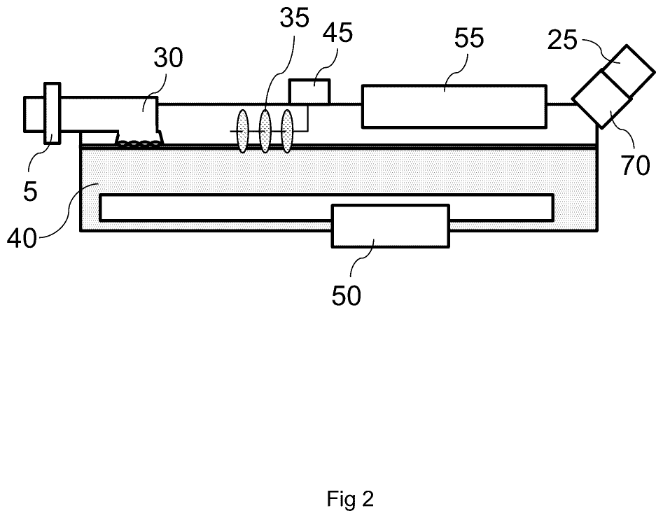

FIG. 3. A schematic representation of an example of a possible embodiment of the capture system. A Lossless Expanded Annular Filter (“LEAF”), containing a pretreatment device 5; an ionic liquid circulation and filtration device 50; annular membranes or surfaces 60 for the ionic liquid 40 to flow upon; means for gas scrubbing (e.g. spray nozzles) 65 to introduce the ionic liquid 40 into the capture chamber 10 from the pipe or tubing leading from the circulation and filtration system 50; a reservoir 140 as part of the ionic liquid filtration and circulation device 50; and an eliminator 70 to prevent ionic liquid from exiting the system.

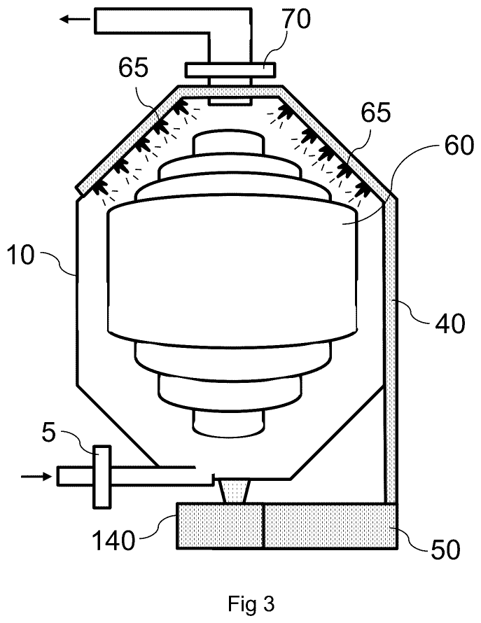

FIG. 4. A schematic representation of an example of a possible embodiment of the capture system. A self-contained home filtration unit with an inflow port 20; a reservoir of ionic liquid 40; means for gas scrubbing (spray nozzles) 65; a moving particle collection device 75; an ionic liquid filtration and circulation device 50; a series of needle spargers or similar bubble-producing sparging mechanisms 80; structured packing materials such as porous balls 85; sparging tank or bubble column 90; means for movement of air (fan or pump) 95; and an eliminator 70.

FIG. 5. A schematic representations of an example embodiment of the invention, highlighting components intended for implementation under variable or micro-gravity conditions. An off-axis centrifugal capture chamber with an ionic liquid impaction volume 40 contained by centrifugal section dividers 100; in-line turbulence inducing baffles 35 and structured packing materials 85; particulate collection device 75; and counterbalance weight 105.

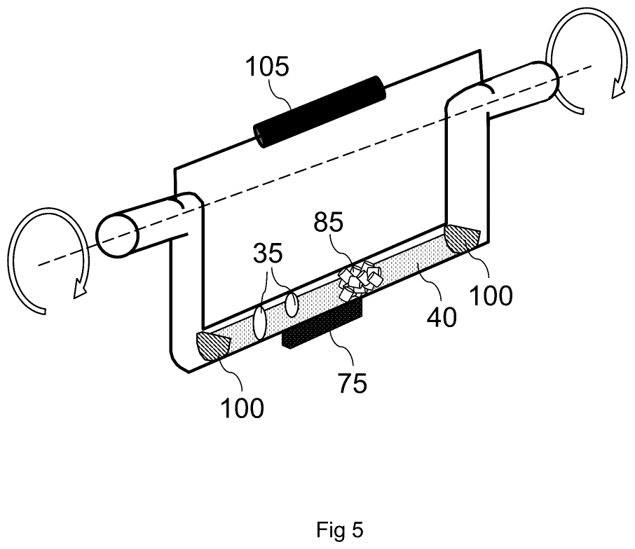

FIG. 6. A schematic representations of an example embodiment of the invention, highlighting components intended for implementation under variable or micro-gravity conditions. An axial centrifugal capture chamber containing an ionic liquid impaction volume 40; directional jets 30 delivering particle-bearing gas to the ionic liquid surface; centrifugal section dividers 100; an axial tribocharging inlet 110; and an axial gas outlet 25.

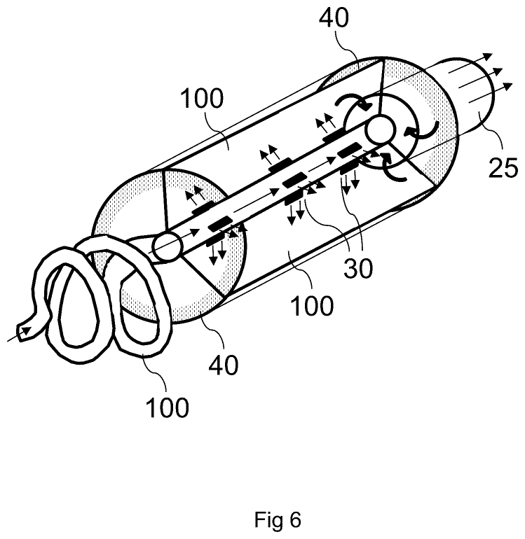

FIG. 7. Schematic representation of an annular tri-phasic centrifugal particle capture device example of an embodiment of the invention, showing (an appliance 145 for entraining gas and particles; a reservoir of ionic liquid 40; an outer mixing annulus 115 where gas particles and ionic liquid are vigorously mixed; an inner centrifuge chamber 120 with a deflection rod 125, where the light phase gas 150 is separated from the heavy phase 155; non-gaseous particles 160 entrained in ionic liquid 40; outgoing gas stream 135; an eliminator 70; a particle collection device 75; and compressed removed particles 165.

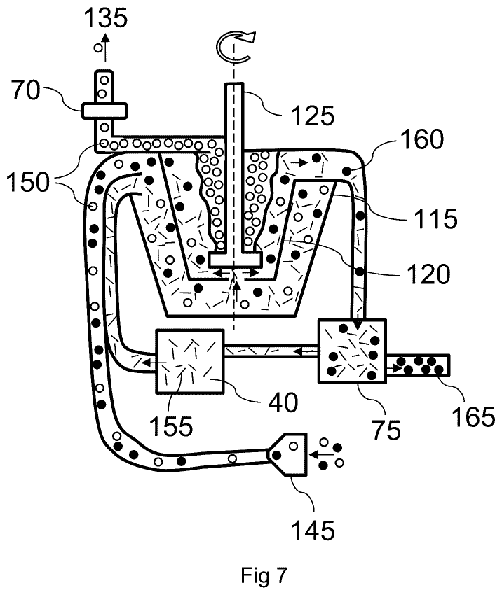

### DETAILED DESCRIPTION

In the most general embodiment, the invention described herein is a novel method and class of devices for the capture of particulates and other non-gaseous impurities, hereinafter collectively referred to as non-gaseous impurities, from a gas stream or environment. This device shall hereinafter be referred to as the capture system.

In some embodiments, the gas stream containing the non-gaseous impurities to be captured may be produced by an external mechanism 1 or process prior to entering the capture system. Examples of external mechanisms 1 and processes that may create the gas stream containing particles or other substances to be captured include, but are not limited to, HVAC units; air circulation devices; furnaces; stoves, ovens; vent hoods; fireplaces; industrial manufacturing mechanisms, machines, and/or processes; scientific equipment; terrestrial and extra-planetary (e.g. space-based and lunar or other planetary bodies) air circulation or processing units; microgravity and extra-planetary air filtration and gas stream filtration or processing systems and habitat climate control systems; spacecraft air filtration and dust mitigation systems; inhalant production devices; vacuum devices; and many others not enumerated here. In other embodiments, the capture system may be a self-contained unit having its own means for the movement air 95 to create a gas stream to filter, such as by using a fan or pump, instead of relying on an exterior process or mechanism.

In those processes where a gas stream is produced by an external process or mechanism 1, the capture system may be situated in-line with the outflowing gas stream from that process or mechanism 1 and have a gas inlet valve 20 or passive opening that is fitted to the outflow port, pipe, vent, duct, or similar part of the external mechanism 1 such that it forms an air-tight seal to prevent any of the incoming gas stream 130 from bypassing the capture system. In other embodiments, the capture system may be situated within ductwork through which the gas stream is flowing, either such that it intercepts all of the air flowing through the duct or a percentage thereof. In most general embodiments, the gas stream containing the non-gaseous impurities is directed from the gas inlet port 20 towards the surface of the ionic liquid 40 contained within the device in the capture chamber 10. Various embodiments may contain a multitude of different mechanisms, apparatuses, devices, flow paths, and geometries, both active and passive, between the gas inlet port 20 and the capture chamber 10 to facilitate or assist the capture of the non-gaseous impurities.

In one class of embodiments, after the incoming gas stream 130 passes the gas inlet port 20 and enters the capture system, it may encounter one or more means for passive effectuation of impaction and wetting in order to alter the incoming gas stream's 130 pressure, velocity, flow, or path in order to optimize the trajectory and momentum of the non-gaseous impurities contained in the gas stream for capture. Examples of passive mechanisms that might be used for this purpose in various embodiments include venturi effect inducing geometries, directional jets 30, cyclonic or vortex accelerators, baffles 35, tortuous pathways, and turbulence inducing topological surfaces. In some embodiments, these passive mechanisms may be the only mechanisms used to create the necessary velocity and flow path of the incoming gas stream 130 to ensure a complete impaction and wetting of the non-gaseous impurities for their capture within the ionic liquid 40. In these embodiments, the non-gaseous impurities entrained in the incoming gas stream 40 have their flow path focused towards the surface of the ionic liquid to achieve impaction and wetting. In some embodiments this alteration of flow path to facilitate impaction and wetting may occur at multiple points or continuously throughout the capture chamber 10.

In other embodiments, the capture system may use one or more means for active effectuation of impaction and wetting to alter the flow path, velocity, or pressure of the incoming gas stream 130. These components include pumps, fans, turbines, and other components similarly situated means for the movement of air 95 to increase the velocity and/or pressure of the incoming gas stream 130 or to alter the direction of flow of said gas stream in order to direct it on an optimal trajectory for impaction and wetting of non-gaseous impurities on the surface of the ionic liquid 40. Various embodiments may use one or more of these components in conjunction with each other or in sequence, along with any one or more of the passive components to increase the capture rate of the non-gaseous impurities.

Various embodiments of the capture system may include means for electromagnetic separation of non-gaseous impurities 55 to enhance the capture efficiency of non-gaseous impurities by the ionic liquid 40.

Embodiments using means for electromagnetic separation of non-gaseous impurities 55 may employ magnetic fields using either or both permanent magnets and electromagnets. The position and alignment of these magnets within the system is determined by the specific geometry of the particular embodiment or device. Since the alteration of a charged, but non-magnetic (para-, ferro-, etc.), particle's trajectory within a magnetic field depends on the velocity vector of that particle, the alignment of the magnetic field, and thus, the most effective placement of the magnet within the capture system, is determined by the flow path of the incoming gas stream 130 and non-gaseous impurities as they enter the capture chamber 10. Electromagnets employed in these embodiments may be static or pulsed to produce an optimal effect. The geometrical configuration of the magnetic field lines shall be optimized for producing the most effective contact angle for non-gaseous impurities with the surface of the ionic liquid 40.

Means for electromagnetic separation of non-gaseous impurities 55 from a gas stream may also involve the use of electrostatic forces in a variety of different configurations and strengths of electric fields to alter the trajectory and velocity of the non-gaseous impurities and guide them to make contact with the collection surface. These means include the integration of ionic liquids 40 with commonly used technologies, such as plate-wire, flat plate, tubular, multistage, and wet electrostatic precipitators. Instead pf a charged collection plate like those used in standard electrostatic precipitators, some of these embodiments of the capture system may use ionic liquids 40 to capture the particles by charging the surface of the ionic liquid 40 or charging a surface that is situated within a pool of ionic liquid, such as electrodes protruding from the surface of the pool, as one possible example. In a different embodiment of this means, another surface may be charged within the capture chamber 10, such as a wall or electrode that is electronically insulated from the ionic liquid 40, with the ionic liquid 40 being connected to an electrical ground. Another possible embodiment using ionic liquids 40 with electrostatic fields is the use of ionic liquids 40 to wash the surface of a collection plate, either continuously or periodically, in the form of a wet electrostatic precipitator. The basic concepts of these technologies are known to those skilled in the art, but the integration of ionic liquids 40 in their function is a novel improvement.

In some of these embodiments, the non-gaseous impurities entering the capture system may be charged by processes or mechanisms prior to entering the system, such as vent ionizers, plasma generation, incidental tribocharging, radioactive bombardment, or other mechanisms. In other embodiments, means to alter the electromagnetic properties of the non-gaseous impurities within the capture system may be used to charge the non-gaseous impurities prior to or upon entrance into the capture chamber 10. These means include tribocharging 110, ionizers, radioactive bombardment, proton beams, plasma generators, and electron beams. Once charged, the non-gaseous impurities can be manipulated by either or both electric and/or magnetic fields to affect their trajectory and effect an impaction with the surface of the ionic liquid 40.

In other embodiments, such as the “LEAF” (Lossless Expanded Annular Filter), the capture of non-gaseous impurities may be effected by the creation of a dramatic increase in the surface area of the phase interface of the ionic liquid 40 and the incoming gas stream 130. This may be accomplished by introducing new surfaces into the flow path of the gas stream, such as thinly stacked layers of trays, pools, or flows of ionic liquid or annuli of membranes 60 with ionic liquid 40 flowing down or across their surface, while simultaneously increasing the dross sectional area of the flow path to minimize turbulent flow and back pressure by lowering the velocity of the incoming gas stream 130 and/or allowing diffusion. In these embodiments, the space between membranes 60 or other surfaces containing the ionic liquid 40 should be small enough that the non-gaseous impurities entrained within the incoming gas stream 130 will be, ideally, statistically certain to contact the surface of the ionic liquid 40, to a certainty beyond 99%, along the flow path of the gas stream between the layers of surfaces, but the large combined cross sectional area of all the spaces leads to only negligible pressure drop across the capture system while accounting for frictional pressure drop.

While the previous descriptions of embodiments envision and utilize a primarily passive surface of ionic liquid 40, either being stationary or flowing over a surface, into which the incoming gas stream 130 or another process such as electromagnetic forces direct the non-gaseous impurities, the ionic liquid 40 may play an active role in other embodiments. This active role may include being sprayed into the gas stream, as in a scrubber 65, or it may be the medium through which the incoming gas stream 130 flows, as in a sparger 80 or bubble column 90. Either or both of these methods may be combined with one or more of the other embodiments described herein to create a specific embodiment of the capture system that is optimized for an intended purpose.

In embodiments using means for gas scrubbing 65, the system may employ the use of ionic liquid 40 in conjunction with a variety of different gas scrubbing technologies within the capture chamber 10. These technologies include spray towers, cyclonic spray towers, dynamic scrubbers, tray towers, Venturi scrubbers, orifice scrubbers, packed tower scrubbers and charged scrubbers. All of these technologies are known to those skilled in the art, though the use of ionic liquids 40 in conjunction with these technologies to capture non-gaseous impurities is a novel improvement there upon.

In embodiments using means for gas sparging 80, the capture chamber may be configured in the form of a bubble column 90 with a sparging nozzle affixed to the gas inlet port, which is submerged within a volume of ionic liquid 40. A variety of different geometries and objects, such as structured packing materials 85, may be used in the flow path of the incoming gas stream 130 through the ionic liquid 40 to increase contact time, induce turbulence and disrupt direct bubble transport through the bubble column 90. The use of bubble columns 90 and sparging technologies 80 as envisioned in the various embodiments presented here are known to those skilled in the art, but are novel in the use of ionic liquid 40 in conjunction with these technologies for the capture of non-gaseous impurities from a gas stream.

In most embodiments of the capture system, the non-gaseous impurities will need to be removed from the ionic liquid after capture through a filtering device 50 in the ionic liquid 40 or a non-gaseous impurities collection device 75, though other embodiments may not require the removal of particles so long as they are cleared from the surface of the ionic liquid 40 to allow for continued capture of more non-gaseous impurities.

In some embodiments, the removal of non-gaseous impurities from the ionic liquid 40 may be achieved by a mechanical filtration device 50. In these embodiments, the ionic liquid 40 might be pumped through a filter 50 to remove the non-gaseous impurities. The filter 50 may be replaceable or self-cleaning, in which case it may clean itself through mechanical scraping, brushing, or similar process, backwashing, in which ionic liquid 40 is pumped backwards through the filter 50 to remove accumulated non-gaseous impurities, air cleaning with a pressurized gas stream, or any other method. In another set of embodiments, the filtration may be achieved through passive or centrifugal settling to regenerate the ionic liquid and recirculate it back into the system.

In other embodiments, the filtration of non-gaseous impurities from the ionic liquid 40 may take place in the capture chamber 10 itself, without removing the ionic liquid 40. This may be achieved by the use of particle collection devices 75, such as plungers, brushes, sponges, or membranes of various types that move through the ionic liquid 40, thus clearing it of accumulated non-gaseous impurities. Centrifugal forces within the capture chamber 10, as described infra, may be used to clear the non-gaseous impurities to the outside of the capture chamber 10, where they may be collected and removed by a scraper or other mechanism.

Some embodiments of the capture system may employ means for annular centrifugation to contact the incoming gas stream 130 containing non-gaseous impurities with the ionic liquid 40. In these embodiments, the capture chamber 10 shall have a gas inlet port 20 for the incoming gas stream 130, a liquid inlet port for circulating the ionic liquid 40, a outer mixing zone 115 in which the ionic liquid 40 and incoming gas stream 130 are combined, a rotor fitted inside the inner centrifuge chamber 120 to aid in mixing the components and also apply centrifugal force to the mixture, a divertor and/or separation vane 125 to demix the components, followed by outlets for the separate phases. The designs and processes involved in annular centrifuges are familiar to those skilled in the art and are in common use across many industries. This particular use of annular centrifugation with ionic liquids for gas filtration is novel and allows for the possibility of capturing large volumes of non-gaseous impurities continuously, while also continuously circulating, filtering, or otherwise regenerating the ionic liquid 40.

In all of the embodiments described supra, the non-gaseous impurities may be disposed of by various means 15. In some embodiments they may be removed to a storage container in either loose or compressed form for later collection, analysis, or use. In other embodiments they may be ejected from the system continuously or periodically into a waste stream or the external environment, in either loose, compressed or aggregated form. Finally, in some embodiments, especially those encountering relatively lower volumes of non-gaseous impurities or in operation for shorter time durations, non-gaseous impurities may accumulate within the ionic liquid 40 in the capture chamber 10. In these embodiments, the only requirement for the accumulation of non-gaseous impurities is that they be cleared from the surface of the ionic liquid 40 to accommodate continued capture of other non-gaseous impurities. This may be achieved by natural gravitational settling, centrifugally induced settling, or by a mechanical process 75, such as a skimmer, comb, or other mechanism.

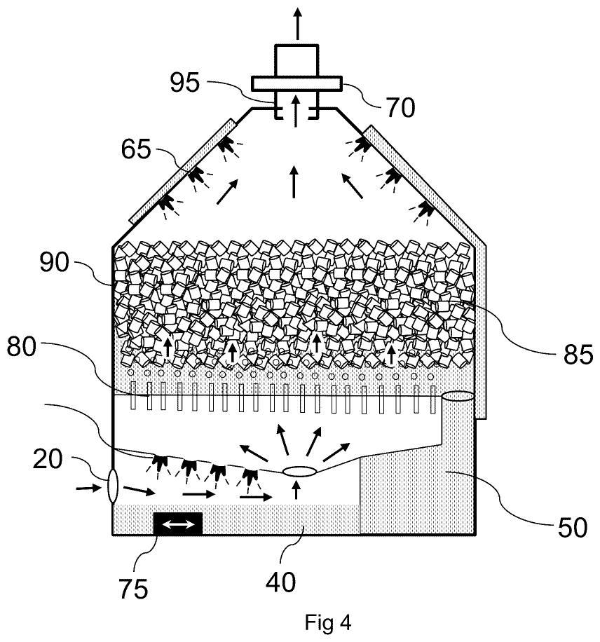

In some embodiments, the capture system may be implemented in micro-gravity or zero gravity environments for aerospace and extra-planetary applications. In these embodiments the liquid and capture chamber 10, along with the entire system, or any portions thereof, may be subjected to centrifugal forces by rotation around a central axis to keep the liquid contained and maintain a surface for impacting and capturing the non-gaseous impurities there upon. In these devices, the geometry of the capture chamber 10 may take many different forms, and may have centrifugal section dividers 100, chambers, or other geometries and surfaces, but are all generally situated to flow an incoming gas stream 130 towards and across the surface of a liquid to effectuate a capture of the non-gaseous impurities entrained within the incoming gas stream 130. Several examples of the various geometries of the capture chamber 10 containing the liquid are shown in FIG. 4. There are a multitude of different broad types of geometries that embodiments of the capture chamber 10 may take, and an infinitude of specific variations of each broad type, thus the designs depicted in FIG. 4 and the description thereof shall only be construed to be exemplary in scope, not exhaustive, and shall not be construed to limit the scope of what is claimed by the inventors. The inventors' novel invention under this embodiment is the general use of a liquid under centrifugal force as part of a gas stream filtration system in microgravity environments. This centrifugally stabilized liquid surface may be combined with any of the embodiments and mechanisms discussed supra to effectuate the filtration and capture of impurities from a gas stream.

Finally, prior to the outgoing gas stream 135 exiting the system through a gas outlet port 25, in most embodiments, the outflowing gas stream 135 may pass through an eliminator 70 or otherwise be cleared of any ionic liquid 40 droplets, mist, or the like that have become entrained in the gas stream. In terrestrial application, any one of several different standard eliminators 70 or similar mechanisms may be implemented. In microgravity application a different method may be used as befitting the specific design and application. include, but are not limited to, a series of rotating or counter-rotating mesh screens, complex and tortuous paths or geometries for the exit flow, baffles or other flow path altering or obstructing apparatuses, centrifugation, valves, impactors, absorption and/or absorption, and other similarly situated mechanisms or devices achieving the desired result of preventing ionic liquid 40 from exiting the system.

What is claimed:

1. A system for the removal of non-gaseous impurities from a gas stream comprising:
a capture chamber having an internal volume and an exterior environment: and
a gas inlet port configured to connect the interior volume of the capture chamber to the exterior environment such that the gas stream may enter the interior volume of the capture chamber from the exterior environment; and
a volume of ionic liquid situated within the capture chamber occupying a portion of the internal volume, with said portion being less than the total volume, such that there exists a surface of the ionic liquid having an interface with the gas stream entering the chamber so as to allow non-gaseous impurities contained within the gas stream to be impacted on said surface, wetted by the ionic liquid and removed from the gas stream; and
a gas outlet port configured to connect the internal volume of the chamber to the external environment and allow the gas stream to exit the chamber.

2. The system of claim 1 wherein means for passive effectuation of impaction and wetting is used to increase the amount of impaction and wetting of non-gaseous impurities contained within the gas stream on the surface of the ionic liquid.

3. The system of claim 1 wherein means for active effectuation of impaction and wetting is used to increase the amount of impaction and wetting of non-gaseous impurities contained within the gas stream on the surface of the ionic liquid.

4. The system of claim 1 wherein the capture and removal of non-gaseous impurities from the gas stream is enhanced by means for electromagnetic separation of non-gaseous impurities from a gas stream.

5. The system of claim 4 wherein the capture and removal of non-gaseous impurities from the gas stream is further enhanced by means for altering electromagnetic properties of non-gaseous impurities.

6. The system of claim 1 wherein the capture chamber contains one or more surfaces aligned parallel to the direction of the gas stream's movement through the capture chamber, with the ionic liquid coating said surfaces and each said surface being spaced minimally apart from other surfaces in the capture chamber by a distance of less than 5 centimeters, while there exists a cross-sectional area of flow path through which the gas stream may move and said cross-sectional area is not reduced within the capture chamber relative to the cross-sectional area of flow path within the gas inlet port.

7. The system of claim 1 wherein the capture and removal of non-gaseous impurities from the gas stream is enhanced by means for gas scrubbing.

8. The system of claim 1 wherein the capture and removal of non-gaseous impurities from the gas stream is enhanced by means for gas sparging.

9. The system of claim 1 wherein the capture and removal of non-gaseous impurities from the gas stream is enhanced by means for annular centrifugation.

10. A method of removing non-gaseous impurities from a gas stream comprising the steps of:
providing a capture chamber containing an ionic liquid; and
moving a gas stream into the capture chamber through a gas inlet port; and
connecting the gas stream with the ionic liquid to capture any non-gaseous impurities contained therein; and
moving the gas stream out of the capture chamber through a gas outlet port.

11. The method of claim 10 further comprising using means for passive effectuation of impaction and wetting for enhancing the capture of non-gaseous impurities.

12. The method of claim 10 further comprising using means for active effectuation of impaction and wetting for enhancing the capture of non-gaseous impurities.

13. The method of claim 10 further comprising using means for electromagnetic separation of non-gaseous impurities for enhancing the capture of non-gaseous impurities.

14. The method of claim 13 further comprising using means for altering the electromagnetic properties of non-gaseous impurities to enhance the effectiveness of said means for electromagnetic separation of non-gaseous impurities.

15. The method of claim 10 further comprising situating one or more surfaces within the capture chamber, aligning the surfaces parallel to the flow path of the gas stream inside the capture chamber, coating the surfaces with the ionic liquid and increasing contact between the ionic liquid and the gas stream by spacing the surfaces minimally apart from one another, while also providing an increased cross-sectional area of flow path for the gas stream relative to that of the gas inlet port.

16. The method of claim 10 further comprising using means for gas scrubbing in order to enhance the capture of non-gaseous impurities.

17. The method of claim 10 further comprising using means for gas sparging in order to enhance the capture of non-gaseous impurities.

18. The method of claim 10 further comprising using means for annular centrifugation in order to enhance the capture of non-gaseous impurities.

19. A method for filtering a gas stream using a liquid comprising the steps of:
providing a volume of liquid inside a chamber; and
rotating the liquid around a central axis so as to create a stable volume of liquid having a stable surface perpendicular to a radial vector extending from the central axis; and
introducing the gas stream into said chamber and contacting it with the liquid volume in order to remove one or more components from said gas stream.

20. The method of claim 19 further comprising using an ionic liquid as the liquid used for filtering the gas stream.
